(19) United States
(12) Patent Application Publication
(10) Pub. No.: US 2011/0013479 A1
(43) Pub. Date: Jan. 20, 2011

(54) Multi-Dimensional Rotary Mixer

(76) Inventors: Bodhisattwa Chaudhuri, Ellington, CT (US); Jason Tomei, Hamden, CT (US); Roshan Shah, Sharon, MA (US); Theodore L. Bergman, Storrs, CT (US)

Correspondence Address: ALIX YALE & RISTAS LLP, 750 MAIN STREET, SUITE 1400, HARTFORD, CT, 06103, US

(21) Appl. No.: 12/836,603

(22) Filed: Jul. 15, 2010

Related U.S. Application Data
(60) Provisional application No. 61/270,943, filed on Jul. 15, 2009.

(51) Int. Cl. B01F 9/00

(52) U.S. Cl. 366/220

(57) ABSTRACT

A multi-dimensional rotary mixer includes a stand, a frame mounted to the stand, and a mixing vessel mounted to the frame. The frame is rotatable around a first axis of rotation and the mixing vessel is rotatable around a second axis of rotation, the second axis of rotation being substantially orthogonal to the first axis of rotation. The mixer also includes a first drive motor coupled to the frame to rotate the frame about the first axis of rotation and a second drive motor mounted to the frame and coupled to the mixing vessel to rotate the mixing vessel about the second axis of rotation.

### CROSS-REFERENCE TO RELATED APPLICATIONS

This application claims the benefit under 35 U.S.C. §119(e) of U.S. Provisional Patent Application Ser. No. 61/270,943 filed Jul. 15, 2009.

### BACKGROUND

This disclosure relates generally to mixing apparatus. More particularly, this disclosure relates to apparatus for mixing solid materials.

Mixing is an important but poorly understood aspect in petrochemical, food, ceramics, fertilizer and pharmaceutical processing and manufacturing. Segregation and mixing phenomenon occur in most systems of powdered or granular solids and have a significant influence on their behavior. Deliberate mixing of granular solids is an essential operation in the production of industrial powder products usually constituted from different ingredients.

The importance of granular mixing to the U.S. economy is tremendous as the production of products ranging from semiconductors to polymers and ceramics increasingly depend on reliable granular flow and uniform granular mixing. For example, the annual cost of inefficient industrial mixing in the U.S. has been estimated to be as high as one trillion dollars. The efficiency of all pharmaceutical products depends on their blend homogeneity. Therefore, inconsistency in the mixture can be extremely detrimental.

Commonly used conventional mixers can be divided into two distinct categories: rotary blenders and convective blenders. While the rotary blenders rely upon the action of gravity to cause the powder to cascade and mix within a rotating vessel, the convective blenders employ an impeller, paddle, blade, or screw which stirs the powder inside a static mixing vessel. Convective blenders exhibit variations in both impeller and vessel geometries, while rotary blenders which rotate around one axis, differ mainly in the geometry of the vessel.

Single axis rotary blenders (mixers) are some of the most common batch mixers used in the pharmaceutical, food, agriculture, and polymer industries. Such equipment finds use in a myriad of applications such as dryers, kilns, coaters, mills and granulators. In most of the rotary mixers, the radial mixing (convection) is faster than the axial mixing (dispersion) of powders. This slow dispersive process hinders the overall granular mixing performance in many blending, drying and coating applications. The double cone mixer's performance is least effective among all types of rotary mixers, e.g., cylindrical drum mixers, v-blenders, or tote-blenders.

### SUMMARY

There is provided a multi-dimensional rotary mixer comprising a stand, a frame mounted to the stand, and a mixing vessel mounted to the frame. The frame is rotatable around a first axis of rotation and the mixing vessel is rotatable around a second axis of rotation, the second axis of rotation being substantially orthogonal to the first axis of rotation.

The mixer may further comprise a first drive motor coupled to the frame to rotate the frame about the first axis of rotation and a second drive motor mounted to the frame and coupled to the mixing vessel to rotate the mixing vessel about the second axis of rotation. The first and second drive motors may be stepper motors.

The mixer may further comprise a control system in electrical communication with the first and second drive motors.

The stand may comprise first and second support members, each of which has a first end adapted to being attached to a base.

The mixer may further comprising first and second axle segments that define the first axis of rotation. Each of the axle segments includes an outer end portion rotatably mounted to one of the support member and an inner end portion mounted to the frame.

The mixing vessel may comprise oppositely disposed first and second outer portions, each having a conical shape or a conical-frustum shape forming an apex, the apexes of the outer portions defining the second axis of rotation.

The mixing vessel also comprises a cylindrical middle portion disposed intermediate the first and second outer portions.

### BRIEF DESCRIPTION OF THE DRAWINGS

The present disclosure may be better understood and its numerous objects and advantages will become apparent to those skilled in the art by reference to the accompanying drawings in which:

FIG. 1 is a simplified front view of a multi-dimensional rotary mixer in accordance with the present disclosure;

FIG. 2 is a top view of the mixer of FIG. 1;

FIG. 3 is a schematic view of the rotary mixer system;

FIGS. 4a, 4b and 4c illustrate the effect of varying the rotational speed of the mixing vessel on the intensity of segregation of the particles over time;

FIG. 5 is a graph illustrating the effect of particle size on the mixing efficiency of the subject rotary mixer;

FIGS. 6a, 6b and 6c illustrate the mixing efficiency of a mixing vessel rotated about a single axis; and

FIGS. 7a, 7b, and 7c illustrate the mixing efficiency of the subject multi-dimensional rotary mixer.

### DETAILED DESCRIPTION

With reference to the drawings wherein like numerals represent like parts throughout the several figures, a multi-dimensional rotary mixer in accordance with the present disclosure is generally designated by the numeral 10.

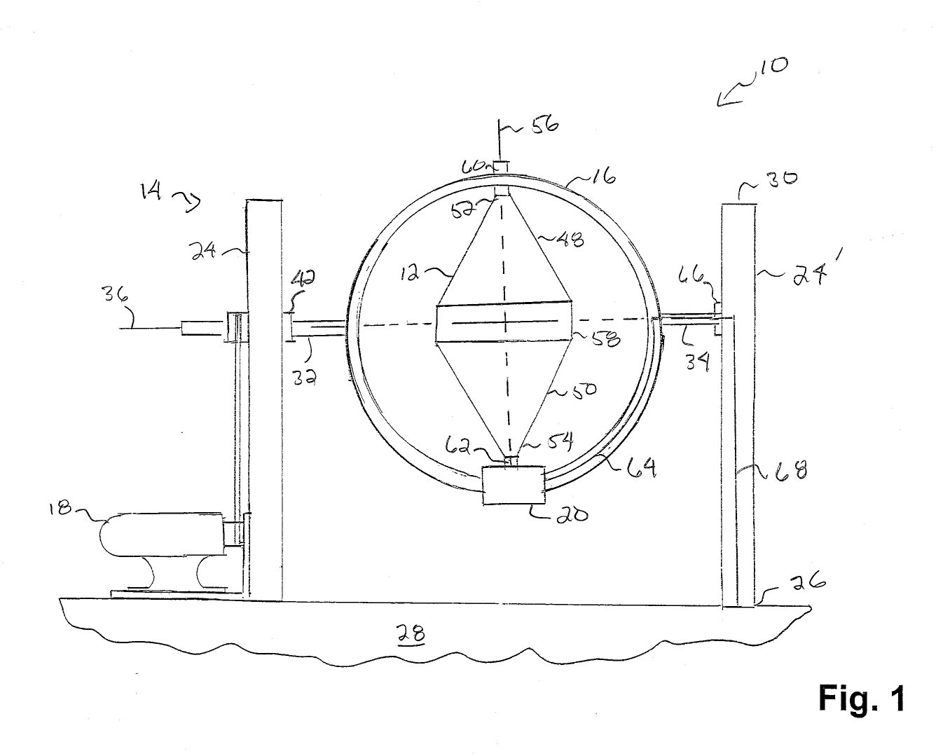

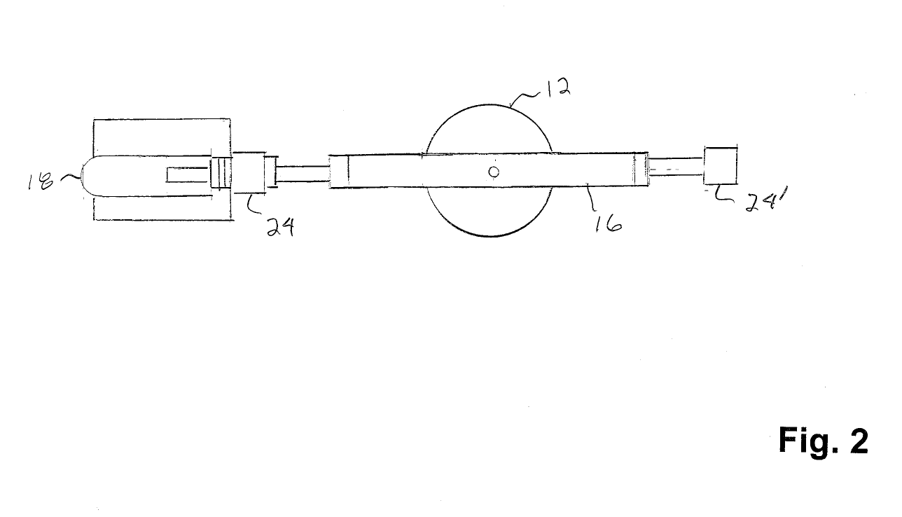

With reference to FIGS. 1 and 2, the rotary mixer 10 includes a mixing vessel 12, a stand 14, a frame 16, first and second drive motors 18, 20 and a control system 22. The stand 14 includes first and second support members 24, 24′ each of which extend from a first end 26 attached to a base 28 to a second end 30. The frame 16 is mounted between the two support members 24, 24′ by first and second axle segments 32, 34, the axle segments 32, 34 defining a first axis of rotation 36 (X axis in the example). The outer end portions 38, 40 of the axle segments 32, 34 are each rotatably mounted to the support members 24, 24′ by bearings 42 and the inner end portions 44, 46 are each fixedly mounted to the frame 16. The frame 16 may be circular in shape as shown in FIG. 1, or any other shape that allows rotation of the mixing vessel 12 as disclosed below.

The two outer portions 48, 50 of the mixing vessel 12 may have a conical shape or a conical-frustum shape, with the apexes 52, 54 of the outer portions 48, 50 defining a second axis of rotation 56 (Y axis in the example) that is orthogonal to the first axis of rotation 36. A cylindrical middle portion 58 may be disposed intermediate the two outer portions 48, 50, as shown in FIG. 1. Alternatively, the base of the first outer portion 48 may be joined to the base of the second outer portion 50. The apex end 52 of the first outer portion 48 is rotatably mounted to the frame 16 by a bearing 60. The apex end 54 of the second outer portion 50 is mounted to a drive shaft 62 that is rotatably mounted to the frame 16 by a bearing 60.

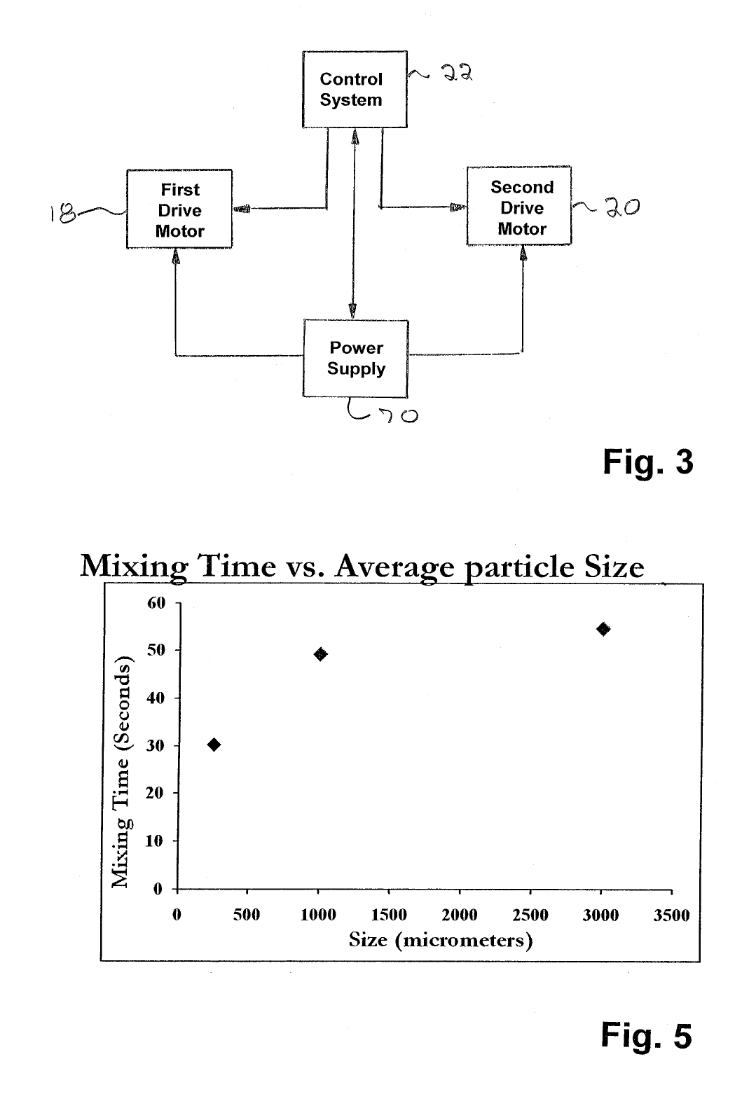

In the example shown in FIGS. 1 and 2, the first drive motor 18 is mounted to the base 28 and coupled to the first axle segment 32, whereby the first drive motor 18 rotates the frame 16 about the first axis of rotation 36. The second drive motor 20 is mounted to the frame 16 and coupled to the mixing vessel drive shaft 62, whereby the second drive motor 20 rotates the mixing vessel 12 about the second axis of rotation 56. In this example, the drive motors 18, 20 are stepper motors, thus any rotational speed (below approximately 50 rpm) can be achieved in both directions. Electricity is supplied to the second drive motor 20 by a first power cable 64 that extends through the frame 16 from the drive motor 20 to one half of a slip ring assembly 66 mounted to the second axle segment 34, a second power cable 68 extends from the second half of the slip ring assembly 66 mounted to one of the support members 24′, through the support member 24′ to a power supply 70 (FIG. 3).

With reference to FIG. 3, a control system 22 controls the operation of the first and second drive motors 18, 20, turning on the drive motors 18, 20 at the beginning a mixing operation and turning off the drive motors 18, 20 at the completion of the mixing operation. In addition, the control system 22 controls the speed and direction of rotation of the frame 16 and the mixing vessel 12 during the mixing operation.

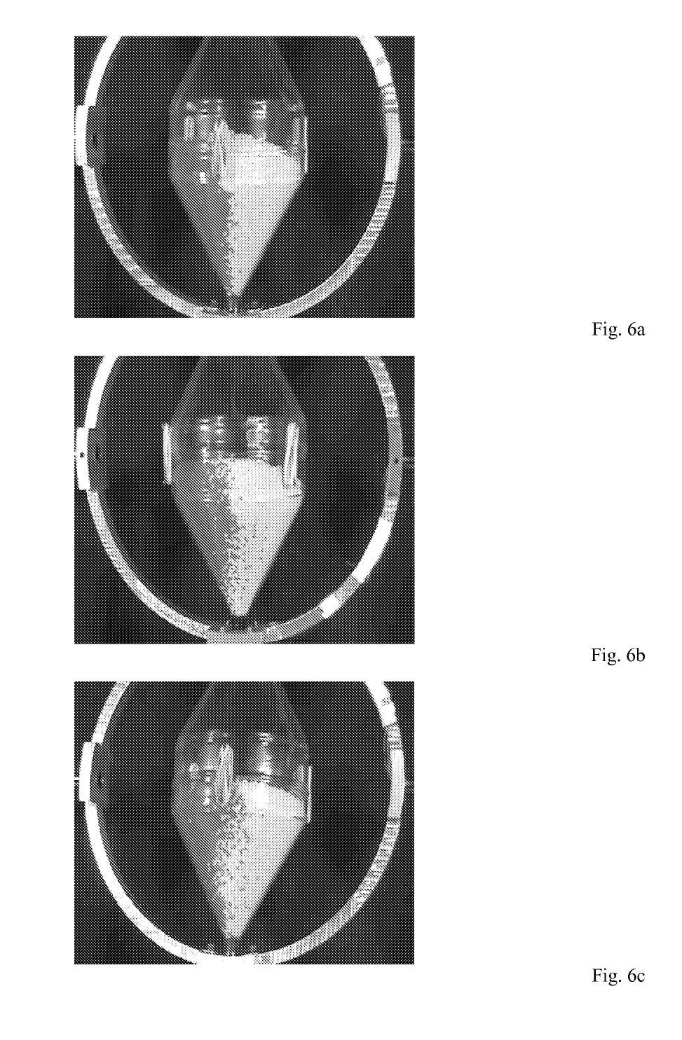

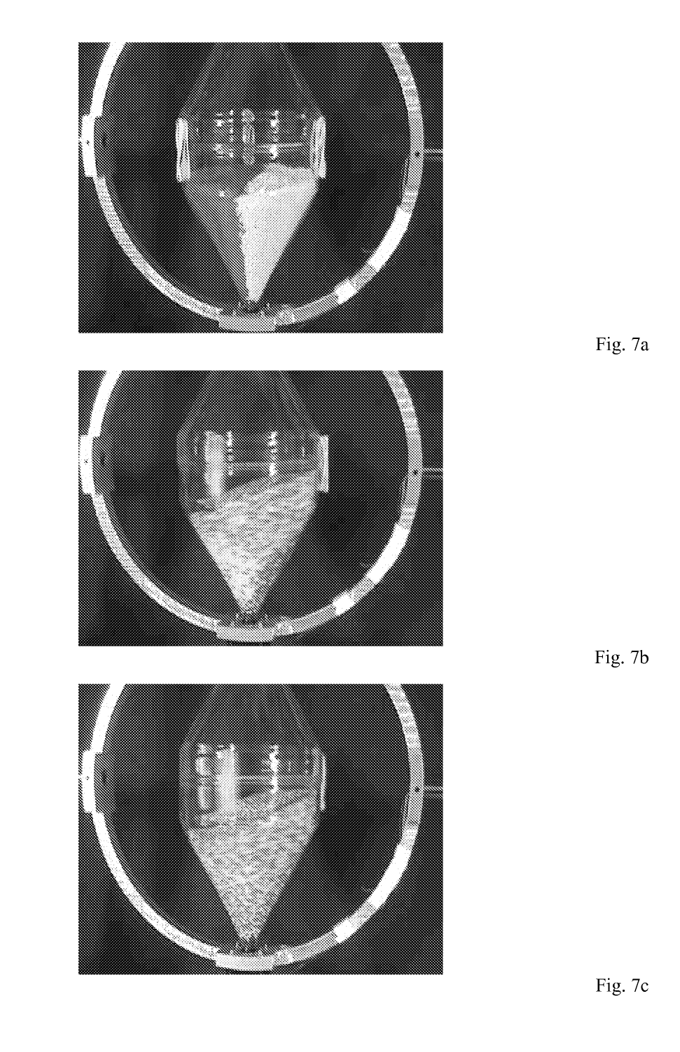

By rotating the mixing vessel 12 around the two orthogonal axes 36, 56 of the mixing vessel 12, the axial mixing rate is improved to be substantially equal to the radial mixing rate, manifesting a significant improvement of overall mixing compared to mixers that rotate around only a single axis, as shown in FIGS. 6a, 6b, 6c and FIGS. 7a, 7b, 7c. FIGS. 6a, 6b, and 6c are photographs of the subject double cone mixing vessel 12 half filed by 3 mm diameter particles. In FIG. 6a, approximately 25,000 “red” particles have been loaded into one side of the mixing vessel 12 and approximately 25,000 “white” particles have been loaded into the other side of the mixing vessel 12. The mixing vessel 12 was then rotated at 30 rpm around the second axis of rotation. The photographs shown in FIGS. 6b and 6c were taken after 2 revolutions and 5 revolutions, respectively. FIGS. 7a, 7b, and 7c are photographs of the subject double cone mixing vessel 12 approximately 40% filed by 3 mm diameter particles, approximately half being “red” particles and half being “white” particles. FIG. 7a shows the mixing vessel 12 initially being loaded with the “red” particles on one side of the mixing vessel 12 and the “white” particles on the other side of the mixing vessel 12. The mixing vessel 12 was then rotated at 30 rpm around the first axis of rotation 36 and 10 rpm around the second axis of rotation 56. The photographs shown in FIGS. 7b and 7c were taken after 2 revolutions and 5 revolutions, respectively.

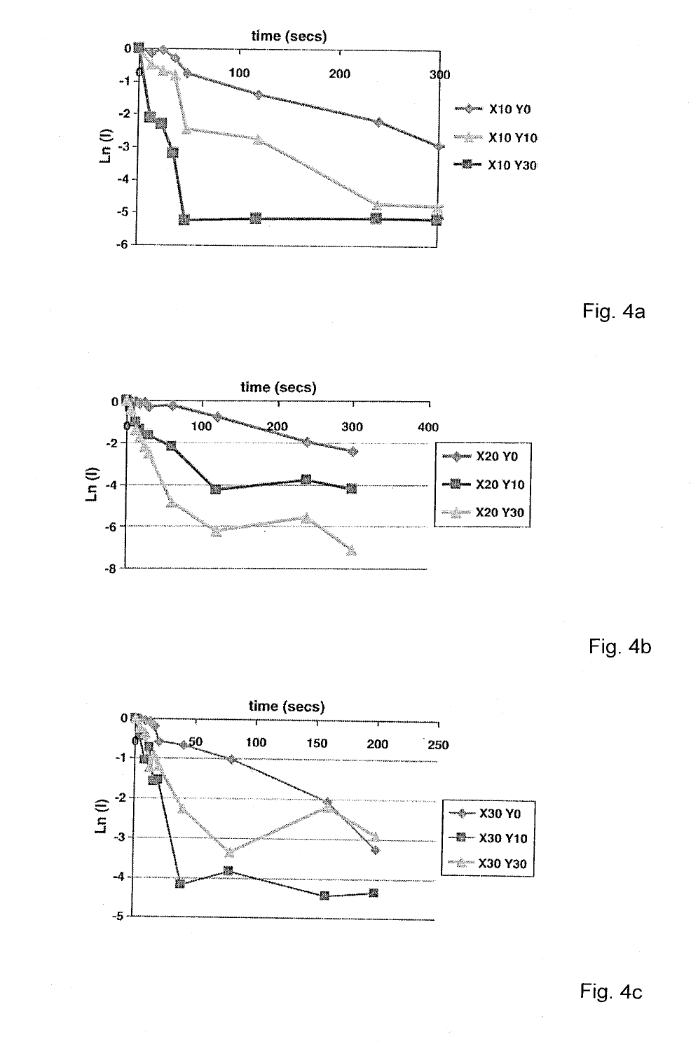

Further experimentation has shown that changing the fill level of the mixer vessel 12 between 10% to 40% had little effect on the mixing of the particles. With reference to FIGS. 4a, 4b and 4c, experimentation has shown that increasing the speed of rotation about both the first axis of rotation 36 (X axis) and the second axis of rotation 56 (Y axis) generally increases the speed at which the particles mix. More specifically, the degree of segregation of the particles generally decreased more quickly as the speed of rotation about either axis 36, 56 increased. With reference to FIG. 5, experimentation has shown that the particle size effects the mixing of the particles to some extent. In this experiment, particles having diameters of 250 microns, 1000 microns and 3000 microns were rotated about the first axis of rotation 36 (X axis) at 10 rpm and the second axis of rotation 56 (Y axis) at 30 rpm. As shown in FIG. 5, the 250 micron particles completed mixing in approximately half the time of the 3000 micron particles.

Incorporation of dual axis rotation reduces the axial mixing time by 60 to 90% in comparison to single axis rotation. A manufacturer using a mixer of the subject disclosure on an industrial scale can save large amounts of resources (time, manpower, energy) because of reduced processing (mixing) time.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A multi-dimensional rotary mixer comprising:
a stand;
a frame mounted to the stand, the frame being rotatable around a first axis of rotation; and
a mixing vessel mounted to the frame, the mixing vessel being rotatable around a second axis of rotation, the second axis of rotation being substantially orthogonal to the first axis of rotation.

2. The mixer of claim 1 further comprising:
a first drive motor coupled to the frame to rotate the frame about the first axis of rotation; and
a second drive motor mounted to the frame and coupled to the mixing vessel to rotate the mixing vessel about the second axis of rotation.

3. The mixer of claim 2 wherein the first and second drive motors are stepper motors.

4. The mixer of claim 2 further comprising a control system in electrical communication with the first and second drive motors.

5. The mixer of claim 1 wherein the stand comprises first and second support members, each of the support members extending from a first end to a second end, each of the support member first ends being adapted to being attached to a base.

6. The mixer of claim 5 further comprising first and second axle segments defining the first axis of rotation, each of the axle segments including:
an outer end portion rotatably mounted to one of the support member; and
an inner end portion mounted to the frame.

7. The mixer of claim 6 wherein the mixing vessel comprises oppositely disposed first and second outer portions, the second outer portion including a drive shaft, the first outer portion and the second outer portion drive shaft being rotatably mounted to the frame.

8. The mixer of claim 7 further comprising:
a first drive motor coupled to the first axle segment to rotate the frame about the first axis of rotation; and
a second drive motor mounted to the frame and coupled to the mixing vessel drive shaft to rotate the mixing vessel about the second axis of rotation.

9. The mixer of claim 8 wherein the first and second drive motors are stepper motors.

10. The mixer of claim 7 wherein the first and second outer portions each have a conical shape or a conical-frustum shape forming an apex, the apexes of the outer portions defining the second axis of rotation.

11. The mixer of claim 10 wherein the mixing vessel also comprises a cylindrical middle portion disposed intermediate the first and second outer portions.

12. The mixer of claim 8 further comprising a control system in electrical communication with the first and second drive motors.

13. A multi-dimensional rotary mixer comprising:
a stand;
a frame mounted to the stand, the frame being rotatable around a first axis of rotation;
a mixing vessel mounted to the frame, the mixing vessel having oppositely disposed first and second outer portions each having a conical shape or a conical-frustum shape forming an apex, the apexes of the first and second outer portions defining a second axis of rotation that is substantially orthogonal to the first axis of rotation, the mixing vessel being rotatable around the second axis of rotation;
a first drive motor coupled to the frame to rotate the frame about the first axis of rotation; and
a second drive motor mounted to the frame and coupled to the mixing vessel to rotate the mixing vessel about the second axis of rotation.

14. The mixer of claim 13 further comprising a control system in electrical communication with the first and second drive motors.

15. The mixer of claim 13 further comprising first and second axle segments, the stand comprising first and second support members, each of the axle segments including an outer end portion rotatably mounted to one of the support members and an inner end portion mounted to the frame, the first and second axle segments defining the first axis of rotation.

16. The mixer of claim 13 wherein the first drive motor is coupled to first axle segment to rotate the frame about the first axis of rotation.

17. The mixer of claim 16 wherein the second outer portion includes a drive shaft, the second drive motor being coupled to the mixing vessel drive shaft to rotate the mixing vessel about the second axis of rotation.

18. The mixer of claim 13 wherein the mixing vessel also has a cylindrical middle portion disposed intermediate the first and second outer portions.

19. A multi-dimensional rotary mixer comprising:
a stand including first and second support members;
a frame assembly including
a frame, and
first and second axle segments, each of the axle segments including an outer end portion rotatably mounted to one of the support members and an inner end portion mounted to the frame, the first and second axle segments defining a first axis of rotation, the frame assembly being rotatable around the first axis of rotation;
a mixing vessel including oppositely disposed first and second outer portions, each of the outer portions having a conical shape or a conical-frustum shape forming an apex, the apexes of the first and second outer portions defining a second axis of rotation that is substantially orthogonal to the first axis of rotation, the mixing vessel being rotatable around the second axis of rotation;
a first drive motor coupled to the frame to rotate the frame about the first axis of rotation;
a second drive motor mounted to the frame and coupled to the mixing vessel to rotate the mixing vessel about the second axis of rotation; and
a control system in electrical communication with the first and second drive motors.

20. The mixer of claim 19 wherein the mixing vessel second outer portion includes a drive shaft, the second drive motor being coupled to the mixing vessel drive shaft to rotate the mixing vessel about the second axis of rotation, and wherein the first drive motor is coupled to first axle segment to rotate the frame about the first axis of rotation.
